(19) United States
(12) Patent Application Publication
(10) Pub. No.: US 2011/0233830 A1
(43) Pub. Date: Sep. 29, 2011

(54) METHOD OF MAKING CUTTING TOOLS

(75) Inventors: Bo Jansson, Ramsberg (SE); Jenni Zackrisson, Fagersta (SE)

(73) Assignee: SECO TOOLS AB, Fagersta (SE)

(21) Appl. No.: 13/128,510

(22) PCT Filed: Nov. 6, 2009
(86) PCT No.: PCT/SE09/51264

§ 371 Date: Jun. 8, 2011

(30) Foreign Application Priority Data
Nov. 10, 2008 (SE) 0802367-3

(51) Int. Cl. C04B 35/64

(52) U.S. Cl. 264/642

(57) ABSTRACT

The present invention relates to a method of reducing dimensional deviations of sintered cemented carbide or cermet cutting tool inserts. According to the method the inserts are heat treated for at least 5 minutes at a temperature higher than the liquidus temperature in a protective atmosphere or vacuum with a controlled maximum temperature gradient over the insert.

The present invention relates to a method of manufacturing cutting tool inserts for metal machining operations such as milling, drilling and turning with improved dimensional accuracy.

Tungsten carbide based alloys, usually referred to as cemented carbides, are used in a wide range of applications. The most important is as materials for cutting tool inserts. In this application the alloy usually comprises a cobalt binder phase and as hard constituent WC and often also a mixed carbide with one or more of the group IVa, Va and/or VIa elements. Another important material group for cutting tool applications is titanium carbonitride based alloys, usually referred to as cermets. They usually comprise a metallic binder phase of cobalt and/or nickel and contain in addition to titanium carbonitride most often carbides, carbonitrides and/or nitrides of one or more of the group IVa, Va and/or VIa elements as hard constituents.

Cutting tool inserts of the above mentioned kinds are produced by powder metallurgical methods. Normally, this includes wet mixing/milling of powders forming binder phase and hard constituents to a slurry which is subsequently spray dried to a ready-to-press (RTP) powder, pressing the RTP powder into compacts with a relative density of about 50% generally uniaxially and finally sintering the compacts placed on graphite trays with a ceramic coating into essentially fully dense cemented carbide or cermet inserts. During sintering the compacts shrink to about half of their original volume.

The dimension and shape of the sintered inserts must have very close tolerances. This is particularly important for inserts for milling. Crucial requirements are homogeneous RTP powder mixture with well dispersed components and homogeneous density in the pressed compact without density gradients. The deviation from desired shape and dimension can also be caused by the sintering operation. One type of sintering related deviation is warpage of the inserts due to uncontrolled carburization or decarburization reactions between the inserts and their environment, i.e., the sintering support or the atmosphere in the sintering furnace, see U.S. Pat. No. 5,151,247. Another well-known type of sintering distortion is related to the effect of gravity. Those types of distortion are problematic primarily for large bodies and alloys having high binder phase content. In production of, e.g., cutting tool inserts, this effect is small and can be compensated for in the press tool design. Another type of distortion is caused by friction between the compact and the sintering tray.

U.S. Pat. No. 5,151,247 discloses a way to alleviate the mentioned carburization or decarburization reactions by the use of an inert gas at high pressures during liquid phase sintering. U.S. Pat. No. 5,993,970 discloses that choosing a proper coating for the graphite support trays can minimize the reactions between the compacts and the support.

EP-A-1468764 discloses a method for reducing dimensional deviations of cemented carbide bodies by placing the bodies in a certain orientation on the sintering tray during sintering. In this way, dimensional deformation caused by the sintering process will compensate for deformation caused by the pressing operation.

Dimensional deviations are conventionally corrected using a post-sintering grinding operation, but this operation gets increasingly more expensive with the magnitude of the deviation. In addition, post-sintering grinding can only be applied when the inserts are over-size. If the inserts are under-size it can not be applied. In such case, the inserts have to be reground to a smaller standard dimension which, of course, is expensive.

It is an object of the present invention to provide a method for producing cutting tool inserts of, e.g., cemented carbide or cermet, which alleviates or reduces the need for a post-sintering grinding operation.

It has surprisingly been found that an unaccepted dimensional deviation from a sintering process can be corrected by a heat treatment. Reheating and re-melting of the binder phase will result in an even distribution in the insert of the liquid binder phase. By controlling the temperature gradient over the insert during the re-solidification of the binder phase, an acceptable dimensional deviation is acquired. The temperature gradient depends on position in the furnace, cooling rate and size of the furnace and is easy to estimate from heat flow calculations. No or very little post grinding is needed.

Thus, the present invention relates to a method of reducing dimensional deviations of sintered cemented carbide or cermet cutting tool inserts. According to the method the inserts are heat treated for at least 5 minutes at a temperature above the liquidus temperature of the alloy, i.e. temperatures above 1380° C. in a protective atmosphere. The temperature gradient over the inserts must be less than the order of 100° C./m. The maximum accepted temperature gradient can be optimized for each individual alloy. The method particularly applies to cemented carbide inserts with high binder phase content, 8-15 wt-%, and/or coarse WC grain size, 1.5-10 μm.

### EXAMPLE

Square inserts of type SNMA1204 were pressed from a powder with the composition 10.2 wt-% Co, 1.5 wt-% TaC balanced by WC having a grain size of 2.5 μm. The solidification of the binder phase after the sintering took place in a temperature gradient of approximately 1000° C./m. The length of the four edges of the sintered inserts was carefully measured with an accuracy of <±5 μm. The edge of the insert that was first solidified was as an average of ten inserts 35 μm longer than the last solidified edge. No significant difference in length of the two edges parallel to the temperature gradient was detected.

The inserts were reheated in another furnace in an inert atmosphere to 1400° C. and held for 30 min. The cooling rate was decreased compared to the initial sintering cycle in order to achieve a temperature gradient of about 25° C./m. The length of the four edges of the reheated inserts was carefully measured with an accuracy of <±5 μm. No significant difference in the length of the four edges was found.

1. Method of reducing dimensional deviations of sintered cemented carbide or cermet cutting tool inserts characterised in heat treating the inserts for at least 5 minutes at a temperature higher than the liquidus temperature of the cemented carbide or cermet in a protective atmosphere or vacuum with a controlled maximum temperature gradient over the insert during the re-solidification.

2. Method according to claim 1 characterised in a maximum temperature gradient during solidification of less than the order of 100° C./m.

3. Method according to claim 1 characterised in that the inserts are of cemented carbide with high binder phase content and/or coarse WC grain size.

4. Method according to claim 3 characterised in a binder phase content of 8-15 wt-%.

5. Method according to claims 3 characterised in an average WC grain size of 1.5-10 μm.
